(19) United States
(12) Patent Application Publication
(10) Pub. No.: US 2026/0115752 A1
(43) Pub. Date: Apr. 30, 2026

(54) MOBILE PAINTING STAND SYSTEM FOR AUTOMOTIVE BODY PANELS

(71) Applicant: US Auto Supply, Elgin, IL (US)

(72) Inventor: Brian James O'Reilly, Pingree Grove, IL (US)

(73) Assignee: US Auto Supply, Elgin, IL (US)

(21) Appl. No.: 18/933,994

(22) Filed: Oct. 31, 2024

(51) Int. Cl. B05B 13/02; F16M 11/10; F16M 11/42

(52) U.S. Cl. CPC B05B 13/0285; F16M 11/10; F16M 11/42

(57) ABSTRACT

A mobile painting stand system for supporting automotive panels comprising a mobile stand base configured to move the mobile painting stand system between locations, a vertical support shaft comprising a proximal end and a distal end, a pivot head subassembly removably coupled to the proximal end of the vertical support shaft, and at least one modular attachment subassembly slidably coupled to the at least one arm extension, where the at least modular attached subassembly is configured to support at least one of the automotive panels.

### FIELD

The preferred implementation relates generally to automotive body painting and repair and particularly to mobile painting stand systems for supporting automotive body panels for painting purposes.

### BACKGROUND

Painting services are essential in many facilities engaged in activities such as auto body repair and auto restoration. In these facilities, automotive body panels are generally painted when removed from the vehicle. Additionally, it is often required that both the inside and outside surface of automotive body panels be painted.

To be able to effectively paint both sides of automotive body panels, painting stand systems are utilized to be mobile and to also hold and secure the body panels during the painting operation. There is need for the painting stand systems to be mobile and to be able expose both sides of the automotive body panels during the painting operation. There is also a need for the painting stand systems to securely hold the automotive panels while facilitating reorienting of the automotive body panel into different positions as the various panel surfaces are painted.

Presently available paint stand systems fail to securely support automotive body panels while providing easy access to the panel surfaces. Presently available paint stand systems are limited in their functionality in meeting the need for mobility of the paint stand system across all surfaces and providing panel movement/reorientation during the painting process.

There remains an unresolved and unfulfilled need in the art for a more efficient mobile paint stand system for support multiple automotive panels while also enabling the appropriate alignment/orientation of the each of the parts, independent of other parts.

### SUMMARY

Disclosed herein are approaches for addressing various of the problems and shortcomings of the state of the art, as identified above. More particularly, disclosed herein are mobile painting stand systems for supporting automotive body panels for painting purposes.

According to a first aspect of the present disclosure, there is provided a mobile painting stand system configured for supporting automotive panels comprising a mobile stand base configured to move the mobile painting stand system between locations, a vertical support shaft comprising a proximal end and a distal end, the distal end removably coupled to the mobile stand base, where a height of the vertical support shaft can be adjusted, a pivot head subassembly removably coupled to the proximal end of the vertical support shaft, and at least one modular attachment subassembly slidably coupled to the at least one arm extension, where the at least modular attached subassembly is configured to support at least one of the automotive panels. The pivot head is configured to rotate about an axis perpendicular to the vertical support shaft and comprises a central stem comprising a proximal end and a distal end, at least one arm comprising a first end and a second end, the at least one arm mechanically coupled to the proximal end of the central stem, and at least one arm extension slidably coupled to at least one of the first end or the second end of the at least one arm of the pivot head.

### BRIEF DESCRIPTION OF THE DRAWINGS

FIG. 1 shows a perspective view of an exemplary aspect of a mobile painting stand system.

FIG. 2A shows a perspective view of an exemplary implementation of a pivot head according to an aspect of the mobile painting stand system.

FIG. 2B shows an exploded view of an exemplary implementation of a pivot head according to an aspect of the mobile painting stand system.

FIG. 3 shows a perspective view of an exemplary implementation of an arm extension according to an aspect of the mobile painting stand system.

FIG. 4A shows a perspective view of an exemplary implementation of a single panel modular attachment subassembly according to an aspect of the mobile painting stand system.

FIG. 4B shows a perspective view of an exemplary implementation of a single panel modular attachment subassembly according to an aspect of the mobile painting stand system.

FIG. 5 shows a perspective view of an exemplary implementation of a multi-panel modular attachment subassembly according to an aspect of the mobile painting stand system.

FIG. 6A shows a perspective view of an exemplary implementation of a vertical support shaft according to an aspect of the mobile painting stand system.

FIG. 6B shows an exploded view of an exemplary implementation of a vertical support shaft according to an aspect of the mobile painting stand system.

FIG. 7 shows a perspective view of an exemplary implementation of a mobile stand base according to an aspect of the mobile painting stand system.

### DETAILED DESCRIPTION

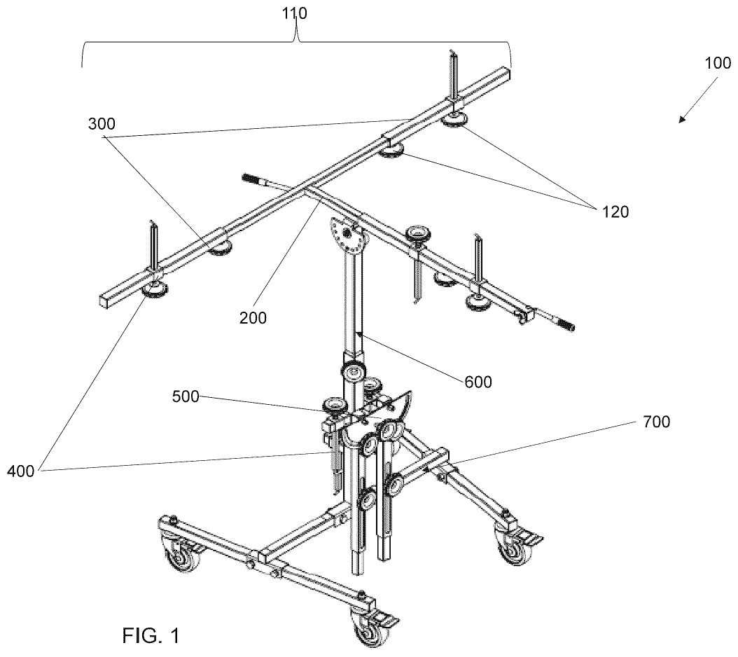

Referring to the drawings, FIG. 1 shows a perspective view of an exemplary aspect of a mobile painting stand system 100. FIG. 1 also presents the primary structural components of the mobile painting stand system 100. These include a pivot head subassembly 110 movably coupled to a vertical support shaft 600, and a mobile stand base 700 also coupled to the vertical support shaft 600. The pivot head subassembly 110 includes a pivot head 200 movably coupled to the vertical support shaft 600, at least one arm extension 300 slidably coupled to the pivot head 200, and at least one modular attachment subassembly 400 slidably coupled to the at least one arm extension 300. In some aspects of the mobile painting stand system 100, such as the exemplary aspect of the mobile painting stand system 100 in FIG. 1, the at least one modular attachment subassembly 400 is a single panel modular attachment subassembly 400 configured to hold at least one automotive panel to be painted. In some aspects of the mobile painting stand system 100, the at least one modular attachment subassembly 400 is a multi-panel modular attachment subassembly 500 configured to hold more than one automotive panel to be painted. In some aspects of the mobile painting stand system 100, the at least one modular attachment subassembly 400 can be at least one of the single panel modular attachment subassembly 400 and at least one of the multi-panel modular attachment subassembly 500. The mobile stand base 700 is configured to confer mobility to the mobile painting stand system 100 which could allow the paint technician to move the mobile painting stand system 100 across different floor surfaces. In some aspects, the mobile painting stand system 100 can be made with square steel tubing. In some aspects, the square steel tubing used is a 16-gauge square steel tubing. In some aspects, the mobile painting stand system 100 can include a surface coating, such as powder coating, to prevent surface degradation during chemical exposure (e.g., automotive part painting).

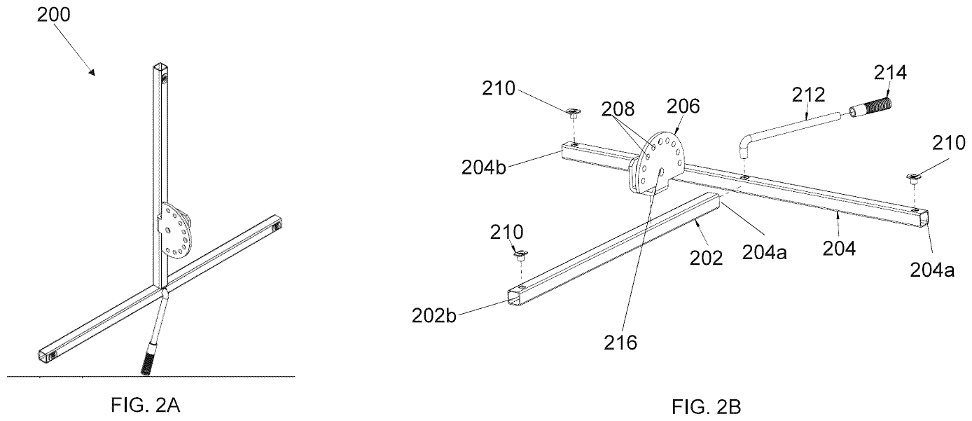

Referring to FIGS. 2A-2B, a perspective view and an exploded view of an exemplary implementation of the pivot head 200 according to an aspect of the mobile painting stand system 100, are shown respectively. The pivot head 200 is movably coupled to the vertical support shaft 600. The pivot head 200 includes a central stem 202 comprising a proximal end 202a and a distal end 202b, and at least one arm 204 mechanically coupled to the proximal end 202a of the central stem 202. The pivot head 200 further comprises a pivot plate 206 mechanically coupled to the central stem 202, and a handle 212 mechanically coupled to the at least one arm 204. In some implementations, the pivot head 200 is coupled to the vertical support shaft 600 via a bushing (not shown in FIGS. 2A-2B) inserted through a bushing insertion point 216 disposed on the pivot plate 206 such that the pivot head 200 is pivoted and is configured to move about the bushing. In some implementations, the handle 212 can include a grip 214 disposed on a distal end of the handle 212. In the implementation of the pivot head 200 shown in FIGS. 2A-2B, the handle 214 can be configured to pivot the pivot head 200 about an axis perpendicular to vertical support shaft 600 at a plurality of pivot angles. In this implementation, each plurality angle of the plurality of angles at which the pivot head 200 can pivot to is determined by placement of a plunger 606 (explained in the paragraphs below) in each of the plurality of plunger insertion points 208 disposed on the pivot plate 206.

Referring to FIGS. 2A-2B, the at least one arm 204 comprises a first end 204a and a second end 204b, where each of the first end 204a and the second end 204b is configured to receive and slidably coupled to the at least one arm extension 300. The at least one arm extension 300 is configured to slide along a length of the at least one arm 204. In some implementations, the central stem 202 can also be configured to receive and slidably coupled to the at least one arm extension 300, as shown in FIG. 1. In the implementations show in FIGS. 2A and 2B, each of the first end 204a and the second 204b further include a tightening nut 210 configured to secure the at least one arm extension 300 to the at least one arm 204, proximal to the first end 204a or the second end 204b. In some implementations, such as the implementation shown in FIG. 2B, the distal end 202b of the central stem 202 can also be configured to receive the at least one arm extension 300 and comprises the tightening nut 210 configured to secure the at least one arm extension 300 to the central stem 202.

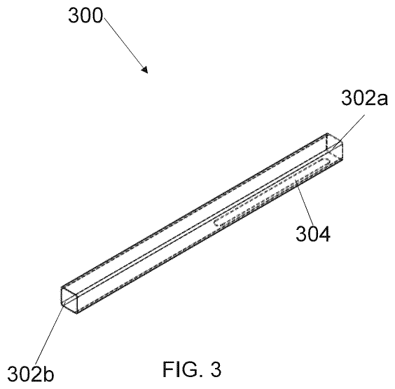

Referring to FIG. 3, a perspective view of an exemplary implementation of the at least one arm extension 300 according to an aspect of the mobile painting stand system 100, is. The at least one arm extension comprises a proximal end 302a and a distal end 302b. The proximal end 302a of the at least one arm extension 300 is configured to slidably couple with the first end 204a or the second end 204b of the at least one arm 200. In some implementations, such as the implementation shown in FIG. 3, the at least one arm extension 300 further comprises a slot 304 disposed proximal to the proximal end 302a of the at least one arm extension 300. The slot 304 can be configured to slidably couple with the tightening nut 210 disposed on the first end 204a and second end 204b of the at least one arm 200, and distal end 202b of the central stem 202. A length of the slot 304 can be configured to limit a distance a sliding distance of the at least one arm extension 300 with respect to the at least one arm 200. In some implementations, the tightening nut 210 can be coupled to a knob 120 (shown in FIG. 1) configured to allow a user to secure the position of the at least one arm extension 300 along the length of the slot 304.

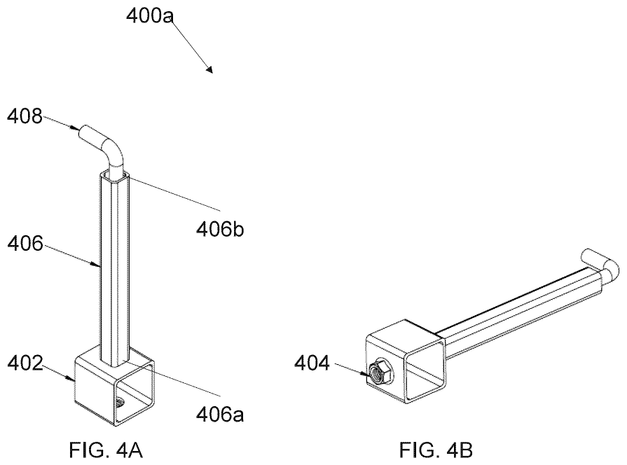

Referring to FIGS. 4A-4B, two perspective views of an exemplary implementation of the single panel modular attachment subassembly 400a according to an aspect of the mobile painting stand system 100, are shown respectively. The single panel modular attachment subassembly 400a includes a base 402 configured to slide over and couple to the at least one arm extension 300, a hook stand 406 with a proximal end 406a and a distal end 406b coupled to the base 402, and a hook 408 disposed on the distal end 406b of the hook stand 406. The proximal end 406a of the hook stand 406 is coupled to the base 402 of the single panel modular attachment subassembly 400a. The hook 408 is configured to support at least one of the automotive panels.

In some implementations, the hook 408 can be shaped to support more than one of the automotive panels. In some implementations, the base 402 of the single panel modular attachment subassembly 400a can be coupled to more than one hook stands 406/hook 408 configured to hold more than one of the automotive panels. In the implementation presented in FIGS. 4A-4B, the base 402 of the single panel modular attachment subassembly 400a further comprises a tightening nut 404 configured to secure the single panel modular attachment subassembly 400 to the at least one arm extension 300. In some implementations, the lock nut 404 can be coupled with a knob 120 (as shown in FIG. 1) to enable the user to tighten or loosen the lock nut 404 and move the single panel modular attachment subassembly 400a along a length of the at least one arm extension 300.

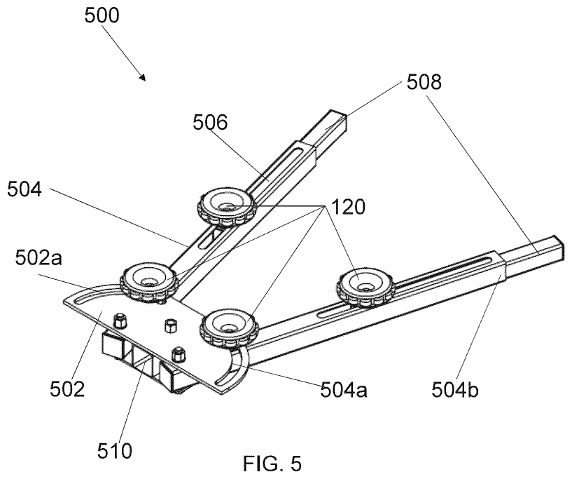

Referring to FIG. 5, a perspective views of an exemplary implementation of the multi-panel modular attachment subassembly 500 according to an aspect of the mobile painting stand system 100, is shown. The multi-panel modular attachment subassembly 500 includes a pivot support arm plate 502, at least one pivot support arm 504 movably coupled to the pivot support arm plate 502, and a pivot support arm extension 508 slidably coupled to the at least one pivot support arm 504. In some implementations, at least one single panel modular attachment subassembly 400a can be slidably coupled to the pivot support arm extension 508 and can be configured to support at least one of the automotive panels. The pivot support arm plate 502 further comprises at least one securing slot 510 configured to slidably couple the multi-panel modular attachment subassembly 500 to the at least one arm 204, at least one arm extension 300, the central stem 202 and/or to the at least one arm extension 300, or the mobile stand base 700.

In the implementation of FIG. 5, a proximal end 504a of the pivot support arm 504 is movably coupled to the pivot support arm plate 502 via a screw and bolt., The pivot support arm plate 502 further comprises a slot 502a through which the knob 120 is coupled proximal to the proximal end 504a of the pivot support arm. The pivot support arm 504 is configured to slide along a length of the slot 502a. The knob 120 can be configured to secure a position of the pivot support arm 504 along the length of the slot 502a by actuation of the knob 120. In some implementations, such as the implementation of FIG. 5, the pivot support arm plate 502 can comprises more than one slot 502a and be movably coupled with more than one pivot support arm 504, where each of the pivot support arms 504 can be configured to slide along the length of the corresponding slot 502a.

Referring to FIG. 5, the at least pivot support arm 504 can further include a sliding slot 506 disposed proximal to a distal end 504b of the at least one pivot support arm 504. In some implementations, such as the implementation of FIG. 5, the knob 120 is coupled to the pivot support arm extension 508 through the sliding slot 506. In this implementation, the pivot support arm extension 508 is configured to slide along a length of the sliding slot 506. The knob 120 can be configured to secure a position of the pivot support arm extension 508 along the length of the sliding slot 502a by actuation of the knob 120.

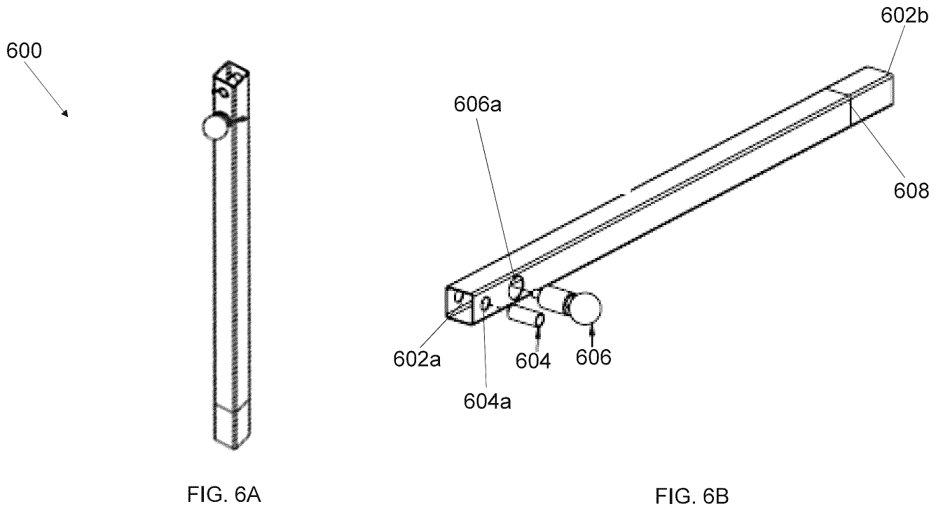

Referring to FIGS. 6A-6B, a perspective view and an exploded view of an exemplary implementation of the vertical support shaft 600 according to an aspect of the mobile painting stand system 100, are shown respectively. In some implementations, the vertical support shaft 600 can be configured to be height adjustable. In some implementations, the vertical support shaft 600 can be height adjusted such that the mobile painting stand system 100 comprises a height range between 40 inches and 62 inches tall, or other heights. In the implementation of the vertical support shaft 600 shown in FIGS. 6A-6B, a distal end 602b of the vertical support shaft 600 is configured to couple to a vertical support shaft connector 708 (explained in the paragraphs below) to connect the vertical support shaft 600 to the mobile stand base 700. In this implementation, the vertical support shaft 600 comprises a stop plate 608 configured to limit a depth at which the vertical support shaft 600 can travel within the vertical support shaft connector 708.

In the implementation of the vertical support shaft 600 shown in FIGS. 6A-6B, the vertical support shaft further includes an insertion point 604a, which lines up with the bushing insertion point 216 disposed on the pivot plate 206, disposed proximally to a proximal end 602a of the vertical support shaft 600. The insertion point 604a (configured to line up with the bushing insertion point 216 disposed on the pivot plate 206 of the pivot head 200) is configured to receive a bushing 604 and allow the pivot head 200 to rotate about the bushing 604. In this implementation, the vertical support shaft 600 further comprises a plunger point 606 (configured to line up with each of the plunger insertion points 212 of the pivot plate 212 of the pivot head 200) disposed proximally to the proximal end 602a of the vertical support shaft 600. The plunger point 606a is configured to receive a plunger 606 configured to secure the pivot head 200 at each plurality angle of the plurality of angles at which the pivot head 200 can pivot to. In some implementations, the plunger 606 can be a retractable plunger comprising a spring configured to automatically return the plunger to an inserted position after being retracted temporarily when moving the pivot head 200 about the bushing 604.

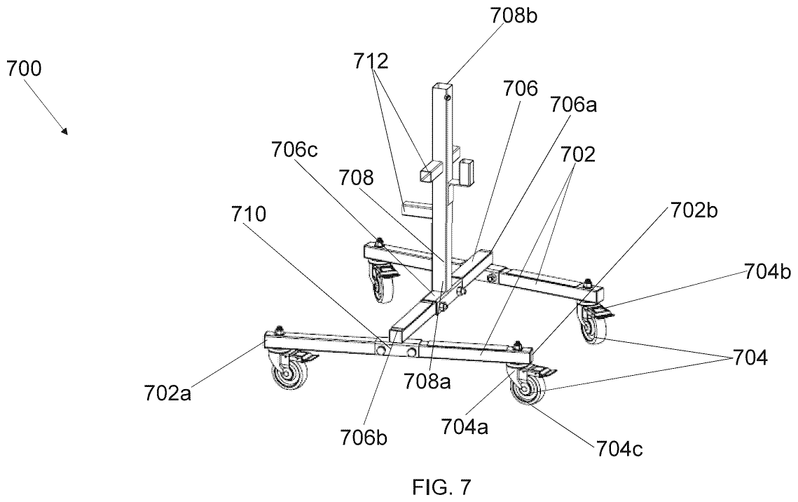

Referring to FIG. 7, a perspective view of the mobile stand base 700 according to an aspect of the mobile painting stand system 100 is shown. The mobile stand base 700 includes at least one support leg 702 with two ends 702a,b and at least one lockable caster 704 disposed on each of the two ends 702a,b of the at least one support leg 702. The at least one support leg 702 can include more than one lockable caster 704. In some implementations of the mobile stand base 700, such as the implementation of FIG. 7, the mobile stand base 700 includes two support legs 702 connected by a bridge 706, where the two ends 706a,b of the bridge 706 are coupled to the two support legs 702 via brackets 710 disposed on the two ends 706a,b. The bridge brackets 710 can be coupled to the support legs 702 via bolts as shown in FIG. 7.

In the implementation of the mobile stand base 700 presented in FIG. 7, the mobile stand base 700 further comprises a vertical support shaft connector 708 disposed on the bridge 706 connecting the two support legs 702. A proximal end 708a of the vertical support shaft connector 708 comprises a bracket 706c configured for coupling to the bridge 706 via screws. The distal end 708b is configured to removably couple to the vertical support shaft 600. In other implementations, the distal end 708b can be configured to be coupled to the vertical support shaft 600 via a screw (not shown in FIG. 7) disposed on the distal end 708 and configured to articulate with a corresponding thread disposed on the vertical support shaft 600. In some implementations, a depth of the vertical support shaft 600 that can be accommodated in the vertical support shaft connector 708 can be limited by the stop plate (not shown in FIGS. 6A-7) disposed in the vertical support shaft 600. In some implementations, the vertical support shaft connector 708 further comprises at least one storage protrusion 712 configured to couple to the at least one modular attachment subassembly 400 and/or multi-panel modular attachment subassembly 500.

In the implementation of the mobile stand base 700 presented in FIG. 7, the at least one lockable caster 704 comprises a swivel bracket 704a configured to allow rotation of the at least one lockable caster, a wheel brake 704b, and a rotatable wheel 704c contained within the swivel bracket 704a. The wheel brake 704b disposed on the swivel bracket 704a can be configured to restrict motion of the rotatable wheel 704c. When the wheel brake 704b is an engaged position, the wheel brake 704b can be configured to directly interface with the rotatable wheel 704c and restricts the motion of the rotatable wheel 704c. When the wheel brake 704c is a disengaged position, the wheel brake 704b can be configured to not interface with the rotatable wheel 704c and therefore not impede motion of the rotatable wheel 704c. In some implementations of the at least one lockable caster 704, the wheel brake 704b can be a foot brake comprising a foot pedal (not shown in the FIG. 7) and configured to switch the wheel brake 704b between the engaged and disengaged positions with the actuation of the foot pedal.

While the advantages and preferred implementations of the present invention have been described hereinbefore, those skilled in the art should be understood that the above are merely several illustrative implementations of the present invention without limiting the scope thereof, wherein various modifications, alterations or substitutions may be made to the specific components of the implementations without departing from the spirit and scope of the invention and its claims.

What is claimed is:

1. A mobile painting stand system comprising:
a mobile stand base, the mobile stand base being configured to move the mobile painting stand system between locations;
a vertical support shaft comprising a proximal end and a distal end, the distal end removably coupled to the mobile stand base, wherein a height of the vertical support shaft can be adjusted; and
a pivot head subassembly removably coupled to the proximal end of the vertical support shaft, the pivot head subassembly comprising:
a pivot head configured to rotate about an axis perpendicular to the vertical support shaft, the pivot head comprising:
a central stem comprising a proximal end and a distal end; and
at least one arm comprising a first end and a second end, the at least one arm mechanically coupled to the proximal end of the central stem; and
at least one arm extension slidably coupled to at least one of the first end or the second end of the at least one arm of the pivot head; and
at least one modular attachment subassembly slidably coupled to the at least one arm extension, the at least modular attached subassembly configured to support at least one automotive panel.

2. The mobile painting stand system of claim 1, wherein the pivot head further comprises:
a pivot plate mechanically coupled to the central stem, the pivot plate configured to rotatably couple the pivot head to the vertical support shaft.

3. The mobile painting stand system of claim 2, wherein the pivot plate further comprises:
a plurality of plunger insertion points, wherein each of the plunger insertion points is configured to receive a plunger disposed on the vertical support shaft; and
a bushing insertion point, wherein the bushing insertion point is configured to receive a bushing and rotatably couple the pivot plate to the vertical support shaft.

4. The mobile painting stand system of claim 3, wherein the pivot head further comprises a handle configured to allow a user to rotate the pivot plate about the bushing to each of the plurality of plunger insertion points.

5. The mobile painting stand system of claim 4, wherein the handle comprises a grip mechanically coupled to the handle.

6. The mobile painting stand system of claim 1, wherein the at least one arm extension comprises:
a proximal end configured to slidably couple to one of the first end or the second end of the at least one arm; and
a distal end configured to receive the at least one modular attachment subassembly.

7. The mobile painting stand system of claim 6, wherein the at least one arm extension further comprises a slot disposed proximal to the proximal end, wherein:
the slot is configured to slidably couple with a tightening nut disposed proximal to the first end or the second end of the arm of the pivot head; and
a length of the slot determining a sliding distance of the at least one arm extension.

8. The mobile painting stand system of claim 1, wherein the at least one modular attachment subassembly is a single panel modular attachment subassembly comprising:
a base configured slidably couple to the at least one arm extension, the base comprising a locknut configured to secure the base to the at least one arm extension;
a hook stand comprising a proximal end and a distal end, the proximal end of the hook stand coupled to the base and the hook stand configured to be oriented perpendicular to the at least one arm extension; and
a hook disposed on the distal end of the hook stand, the hook configured to support the at least one of the automotive panels.

9. The mobile painting stand system of claim 1, wherein the at least one modular attachment subassembly is a multi-panel modular attachment subassembly comprising:
a pivot support arm plate comprising at least one slot;
a securing slot coupled to the pivot support arm plate, the securing slot configured to slidably secure the multi-panel modular attachment subassembly to the at least one arm extension;
at least one pivot support arm comprising a proximal end and a distal end, the proximal end of the at least one pivot support arm movably coupled to the pivot support arm plate; and
a pivot support arm extension slidably coupled to the distal end of the at least one pivot support arm, the pivot support arm extension configured to slidably couple to a single panel modular attachment subassembly comprising:
a base configured slidably couple to the pivot support arm extension, the base comprising a locknut configured to secure the base to the pivot support arm extension;
a hook stand comprising a proximal end and a distal end, the proximal end of the hook stand coupled to the base and the hook stand configured to be oriented perpendicular to the pivot support arm extension; and
a hook disposed on the distal end of the hook stand, the hook configured to support the at least one of the automotive panels.

10. The mobile painting stand system of claim 9, further comprising a first knob coupled to the at least one pivot support arm via the at least one slot disposed on the pivot support arm plate, wherein the at least one pivot support arm is configured to slide along a length of the at least one slot.

11. The mobile painting stand system of claim 10, wherein the at least one pivot support arm further comprises:
a sliding slot disposed proximal to the distal end of the at least one pivot support arm; and
a second knob coupled to the pivot support arm extension via the sliding slot, wherein the pivot support arm extension is configured to slide along a length of the sliding slot.

12. The mobile painting stand system of claim 9, wherein the securing slot can be further configured to couple the multi-panel modular attachment subassembly to the mobile stand base.

13. The mobile painting stand system of claim 1, wherein the mobile stand base comprises:
at least one support leg comprising two ends; and
at least one lockable caster disposed on each of the two ends of the at least one support leg.

14. The mobile painting stand system of claim 13, wherein the at least one lockable caster comprises:
a swivel bracket configured to allow rotation of the at least one lockable caster;
a rotatable wheel contained with the swivel bracket; and
a wheel brake disposed on the swivel bracket and configured to restrict motion of the rotatable wheel in an engaged position.

15. The mobile painting stand system of claim 13, wherein the at least one support leg comprises two support legs connected by a bridge disposed between both support legs, wherein each of the support legs comprises at least one lockable caster.

16. The mobile painting stand system of claim 15, wherein the mobile stand base further comprises a vertical support shaft connector disposed on the bridge and configured to removably couple to the distal end of the vertical support shaft

17. The mobile painting stand system of claim 16, wherein the vertical support shaft connector comprises at least one storage protrusion configured to secure the at least one modular attachment subassembly.

18. The mobile painting stand system of claim 3, wherein the vertical support shaft further comprises:
an insertion point disposed proximally to the proximal end of the vertical support shaft, the insertion point configured to:
line up with the bushing insertion point pivot plate; and
receive the bushing; and
a plunger point disposed proximally to the proximal end of the vertical support shaft, the plunger point configured to:
line up with the each of the plurality of plunger insertion points disposed on the pivot plate; and
receive the plunger configured to lock the pivot head at an angle corresponding to the each of the plurality of plunger insertion point.

19. The mobile painting stand system of claim 18, wherein the plunger is a retractable plunger comprising a spring configured to automatically return the plunger to an inserted position when the plunger is retracted.

20. A mobile painting stand system comprising:
a mobile stand base comprising two support legs and at least two lockable casters disposed on each of the support legs, the mobile stand base being configured to move the mobile painting stand system between locations;
a vertical support shaft comprising a proximal end and a distal end, the distal end removably coupled to the mobile stand base; and
a pivot head subassembly removably coupled to the proximal end of the vertical support shaft, the pivot head subassembly comprising:
a pivot head configured to rotate about an axis perpendicular to the vertical support shaft, the pivot head comprising:
a central stem comprising a proximal end and a distal end; and
an arm comprising a first end and a second end, the at least one arm mechanically coupled to the proximal end of the central stem; and
two arm extensions slidably coupled to each of the first end and the second end of the arm of the pivot head; and
at least three modular attachment subassemblies each slidably coupled to each of the two arm extensions and the distal end of the central stem, wherein each of the at least three modular attachment subassemblies are configured to support at least one automotive panel.
